(19) United States
(12) Patent Application Publication
(10) Pub. No.: US 2015/0061935 A1
(43) Pub. Date: Mar. 5, 2015

(54) METHOD AND APPARATUS FOR MODELING RADIO WAVE ENVIRONMENT

(71) Applicant: ELECTRONICS AND TELECOMMUNICATIONS RESEARCH INSTITUTE, DAEJEON (KR)

(72) Inventors: Hyun-ja IM, Daejeon (KR); Chang Eun LEE, Daejeon (KR); Min Su JANG, Daejeon (KR); Daeha LEE, Daejeon (KR); Seohyun JEON, Daejeon (KR); Young-Jo CHO, Daejeon (KR); Sung Hoon KIM, Daejeon (KR); Jong-Hyun PARK, Daejeon (KR)

(73) Assignee: ELECTRONICS AND TELECOMMUNICATIONS RESEARCH INSTITUTE, DAEJEON (KR)

(21) Appl. No.: 14/163,539

(22) Filed: Jan. 24, 2014

(30) Foreign Application Priority Data
Sep. 3, 2013 (KR) 10-2013-0105508

(51) Int. Cl. H04B 17/00; H04B 7/04

(52) U.S. Cl. CPC H04B 17/009; H04B 7/0408
USPC 342/360

(57) ABSTRACT

A method of modeling a radio wave environment, the method being executed by a radio wave environment modeling apparatus using a group of intelligent robots includes measuring an intensity of radio waves received from at least one follower robot; measuring a distance between the at least one follower robot and a leader robot that belongs to the group of intelligent robots; and estimating an environment parameter using a wave model. Further, the method includes classifying the environment parameter estimated from at least one lattice by comparing the estimated environment parameter with predetermined environment parameters; and analogizing an intensity of radio waves of the at least one follower robot that are received from the at least one lattice.

### CROSS-REFERENCE TO RELATED APPLICATION(S)

The present invention claims priority of Korean Patent Application No. 10-2013-0105508, filed on Sep. 3, 2013, which is incorporated herein by reference.

### FIELD OF THE INVENTION

The present invention relates to a method and apparatus for modeling a radio wave environment; and more particularly, to a method and apparatus for predicting a radio wave environment that changes in real time in an atypical environment.

### BACKGROUND OF THE INVENTION

Recently, with an increase in the use of robots, research has been actively conducted in various fields. Research into a group of intelligent robots has been conducted in line with the results of research indicating that when the range of work of a robot is wide and the work is complicated, the use of a group of intelligent robots is more efficient than that of a single robot.

A method for communication between a group of robots is performed by constructing a network topology for each communication group. In connection with this communication method, Korean Patent Application Publication No. 2013-0068248 (published on Jun. 26, 2013) discloses a configuration in which a communication path is searched for in order to transmit messages between a group of robots based on an atypical environment network.

However, the conventional communication method cannot be rapidly applied to the case where a change in a radio wave environment cannot be predicted or the case of a catastrophic situation in which an infrastructure has been destroyed. Furthermore, the Korean patent application publication does not disclose a method of handling a radio wave environment that rapidly changes depending on a change in an environment in the operation of a group of intelligent robots.

### SUMMARY OF THE INVENTION

In view of the above, the present invention provides a method and apparatus for modeling a radio wave environment, which are capable of estimating an environment parameter using information about communication between a leader robot and at least one follower robot in an atypical environment, classifying environment parameters around the robots, and applying the distance between a lattice and at least one follower robot having the same environment parameter to a wave model, thereby constructing a radio wave map. However, an object to be achieved by the present embodiment is not limited to the aforementioned object, and there may be other objects.

In accordance with a first aspect of the present invention, there is provided a method of modeling a radio wave environment, the method being executed by a radio wave environment modeling apparatus using a group of intelligent robots. The method includes: measuring an intensity of radio waves received from at least one follower robot; measuring a distance between the at least one follower robot and a leader robot that belongs to the group of intelligent robots; estimating an environment parameter using a wave model; classifying the environment parameter estimated from at least one lattice by comparing the estimated environment parameter with predetermined environment parameters; and analogizing an intensity of radio waves of the at least one follower robot that are received from the at least one lattice.

Further, the environment parameter may be an attenuation rate of reception power over distance.

Further, the wave model may be a log-distance path loss model.

Further, the wave model may be defined by the following Equation:

$$L = {L}_{0} + {10}_{n} log ( \frac{d}{{d}_{0}} ) + \overline{ω}$$

where L is the reception power, L₀ is reception power at a point d₀ between the at least one follower robot and the leader robot, d is the distance between the at least one follower robot and the leader robot, n is the environment parameter, and ω̅ is noise.

Further, the environment parameter may be estimated using a filter.

Further, analogizing an intensity of radio waves of the at least one follower robot that are received from the one or more lattices may be performed using a non-parametric density estimation method.

Further, analogizing an intensity of radio waves of the at least one follower robot that are received from the at least one lattice may be performed based on the following Equation:

Xₘᵢₙ=arg minₓ_{_{iεx}}{d(x,xᵢ)}

y(x)=y(xₘᵢₙ)

where d(*,*) is a distance function, x is a lattice value, xᵢ is a position in the at least one follower robot, and y(x) is an environment parameter in the lattice x.

Further, the method may further comprise constructing a radio wave map using the intensity of radio waves of the at least one follower robot that has been analogized for the at least one lattice.

Further, an environment in which the at least one follower robot are placed may be analogized by comparing the environment parameter estimated from the at least one lattice with the predetermined environment parameters.

In accordance with a second aspect of the present invention, there is provided a apparatus for modeling a radio wave environment using a group of intelligent robots. The apparatus includes an intensity measurement unit configured to measure an intensity of radio waves received from at least one follower robot; a distance measurement unit configured to measure a distance between the at least one follower robot and a leader robot that belongs to the group of intelligent robots; an estimation unit configured to estimate an environment parameter using a wave model; a classification unit configured to classify the environment parameter estimated from the at least one lattice by comparing the estimated environment parameter with predetermined environment parameters; and an analogy unit configured to analogize an intensity of radio waves of the at least one follower robot which are capable of being received from the one or more lattices.

Further, the intensity measurement unit may measure the intensity of radio waves using at least one medium between the at least one follower robot and the leader robot.

Further, the wave model may be defined by the following Equation:

$$L = {L}_{0} + {10}_{n} log ( \frac{d}{{d}_{0}} ) + \overline{ω}$$

where L is the reception power, L₀ is reception power at a point d₀ between the at least one follower robot and the leader robot, d is the distance between the at least one follower robot and the leader robot, n is the environment parameter, and ω̅ is noise.

Further, the analogy unit may analogize the intensity of radio waves of the at least one follower robot that are received from the at least one lattice based on the following Equation:

xₘᵢₙ=arg minₓ_{_{iεx}}{d(x,xᵢ)}

y(x)=y(xₘᵢₙ)

where d(*,*) is a distance function, x is a lattice value, xᵢ is a position in the at least one follower robot, and y(x) is an environment parameter in the lattice x.

In accordance with an embodiment of the present invention, a radio wave environment that changes in real time can be predicted using information about communication between a group of intelligent robots in an atypical environment.

### BRIEF DESCRIPTION OF THE DRAWINGS

The above and other objects and features of the present invention will become apparent from the following description of embodiments given in conjunction with the accompanying drawings, in which:

FIG. 1 is a configuration diagram illustrating a group of intelligent robots in accordance with an embodiment of the present invention;

FIG. 2 is a configuration diagram illustrating the radio wave environment modeling apparatus of the leader robot illustrated in FIG. 1;

FIG. 3 is a diagram illustrating an embodiment in which the radio wave environment modeling apparatus of FIG. 1 models a radio wave environment; and

FIG. 4 is a flow chart illustrating a method of modeling a radio wave environment in accordance with an embodiment of the present invention.

### DETAILED DESCRIPTION OF THE EMBODIMENTS

Hereinafter, embodiment of the present invention will be described in detail with reference to the accompanying drawings so that they can be readily implemented by those skilled in the art.

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

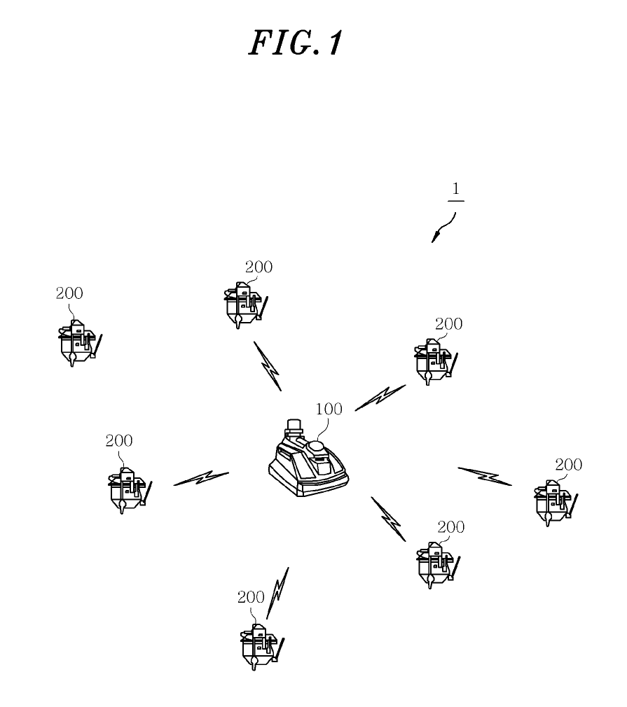

FIG. 1 is a configuration diagram illustrating a group of intelligent robots in accordance with an embodiment of the present invention. Referring to FIG. 1, the group of intelligent robots 1 in accordance with this embodiment of the present invention may include a leader robot 100 and at least one follower robot 200. The group of intelligent robots 1 illustrated in FIG. 1 is merely an embodiment of the present invention, and thus the present invention should not be construed as being limited to the embodiment of FIG. 1. Since the leader robot 100 performs a method of modeling a radio wave environment in accordance with an embodiment of the present invention, the leader robot 100 is assigned the same reference numerals as a apparatus 100 for modeling a radio wave environment.

The elements of FIG. 1 may be typically connected over a wireless network. For example, as illustrated in FIG. 1, the leader robot 100 and the at least one follower robot 200 may be connected over a wireless network. If the at least one follower robot 200 includes a plurality of follower robots, the plurality of follower robots may be connected over a wireless network. The leader robot 100 and the at least one follower robot 200 illustrated in FIG. 1 are not limited to those illustrated in FIG. 1.

When the group of intelligent robots 1 performs their tasks, the most basic function is communication between the robots 1. The capability to communicate between the leader robot 100 that belongs to the group of intelligent robots 1 and the at least one follower robot 200 is the most important issue in the establishment of cooperation policies. In the performance of tasks using the group of intelligent robots 1, such as searching and rescue, the establishment of a seamless network between the leader robot 100 and the at least one follower robot 200 is an essential requirement. For this purpose, the apparatus 100 for modeling a radio wave environment in accordance with an embodiment of the present invention predicts and models a radio wave environment that varies in real time using information about communication between the robots.

The leader robot 100 may include the apparatus 100 for modeling a radio wave environment. The apparatus 100 for modeling a radio wave environment may measure the intensity of radio waves and distance from the at least one follower robot 200, and may estimate an environment parameter of an environment where the at least one follower robot 200 is placed using a wave model. In this case, the apparatus 100 for modeling a radio wave environment may classify environment parameters by comparing an environment parameter estimated from at least one lattice with predetermined environment parameters, and may analogize the intensity of radio waves of the at least one follower robot 200 that may be received from the at least one lattice. Accordingly, the apparatus 100 for modeling a radio wave environment in accordance with this embodiment of the present invention may predict a radio wave environment that varies in real time using information about communication between the leader robot 100 and the at least one follower robot 200 in an atypical environment.

The at least one follower robot 200 enables the leader robot 100 to measure the intensity of radio waves of the at least one follower robot 200 through communication with the leader robot 100. The at least one follower robot 200 may receive a control signal from the leader robot 100, or may update its current data stored in the leader robot 100 through communication with the leader robot 100.

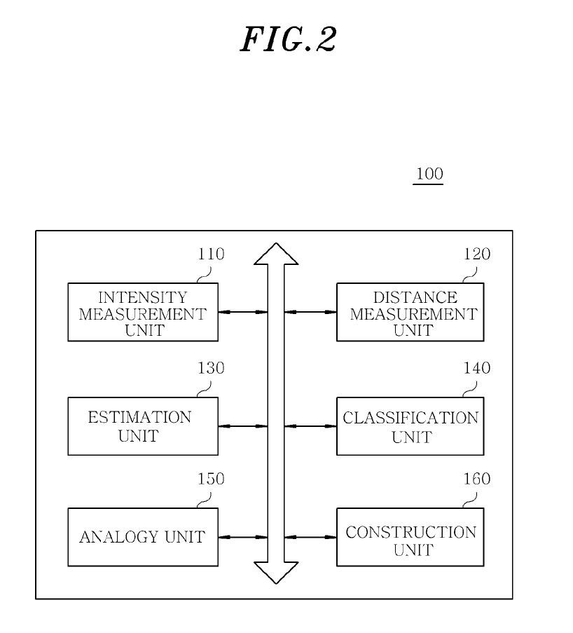

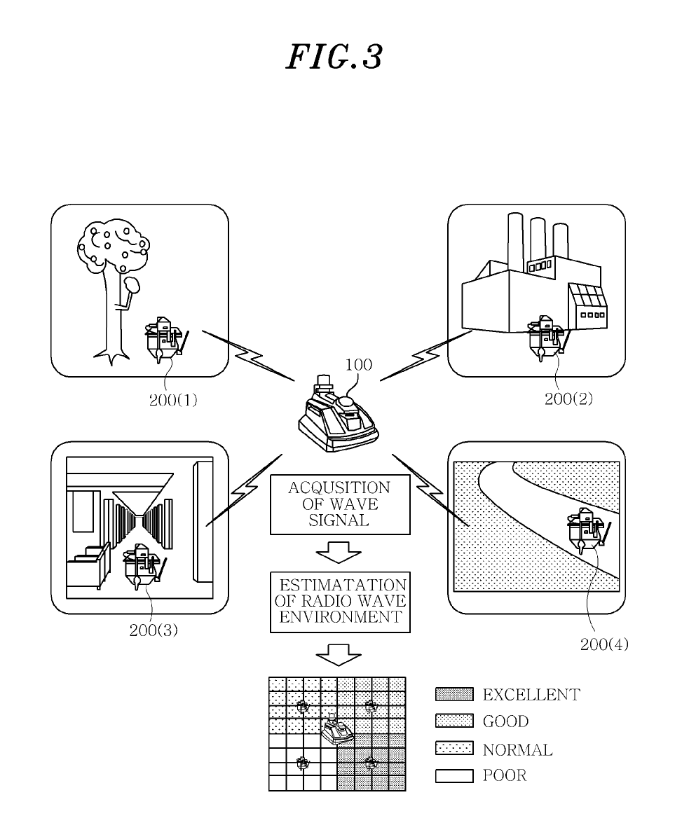

FIG. 2 is a configuration diagram illustrating the radio wave environment modeling apparatus of the leader robot illustrated in FIG. 1, and FIG. 3 is a diagram illustrating an embodiment in which the radio wave environment modeling apparatus of FIG. 1 models a radio wave environment.

Referring to FIG. 2, the apparatus 100 for modeling a radio wave environment in accordance with an embodiment of the present invention may include an intensity measurement unit 110, a distance measurement unit 120, an estimation unit 130, a classification unit 140, an analogy unit 150, and a construction unit 160.

The intensity measurement unit 110 measures the intensity of radio waves that may be received from the at least one follower robot 200. The intensity measurement unit 110 may measure the intensity of radio waves using at least one type of medium between the at least one follower robot 200 and the leader robot 100. The at least one type of medium may be, for example, ultraviolet rays, infrared rays, or radio waves.

The distance measurement unit 120 measures the distance between the at least one follower robot 200 and the leader robot 100 that belongs to the group of intelligent robots 1.

The estimation unit 130 estimates an environment parameter using a wave model. The wave model may be a log-distance path loss model, and may be defined by the following Equation 1:

$$L = {L}_{0} + {10}_{n} log ( \frac{d}{{d}_{0}} ) + \overline{ω} \qquad ( 1 )$$

where L is reception power, L₀ is reception power at a point d₀ (e.g., 1 m) between the at least one follower robot 200 and the leader robot 100, d is the distance between the at least one follower robot 200 and the leader robot 100, n is an environment parameter, and ω̅ is noise.

In this case, the environment parameter may be the attenuation rate of the reception power over distance, the estimation unit 130 may use a filter in order to estimate an environment parameter, and the filter may be, for example, an extended Kalman filter. When a structure is complicated and many obstacles are present, the value of the environment parameter increases. Furthermore, the environment parameter is a value indicative of the slope of a wave model, and is called a loss coefficient because a signal is highly attenuated over a short distance in response to an increase in the value. The environment parameter may be a value that is the most important index in order to predict the discontinuation of radio waves in a method of modeling a radio wave environment according to the present invention. Indices based on the environment may be classified as listed in the following Table 1:

TABLE 1

| ENVIRONMENT | SLOPE INDEX N |
|---|---|
| Free Space | 2 |
| Urban Area | 2.7 to 3.5 |
| Shadowed Urban Area | 3 to 5 |
| Indoor Line Of Sight (LOS) | 1.6 to 1.8 |
| Indoor No LOS | 4 to 6 |

A value that is analogized by the apparatus 100 for modeling a radio wave environment in accordance with the embodiment of the present invention is a slope index n. The reason for this is that if a slope index n in a specific area is predicted, it is possible to approximately analogize a corresponding environment that is similar to a radio wave environment in Table 1.

Returning to FIG. 2, the classification unit 140 classifies an environment parameter estimated from at least one lattice by comparing the estimated environment parameter with predetermined environment parameters. In this case, it is possible to analogize an environment in which the at least one follower robot 200 is placed by comparing the environment parameter estimated from the at least one lattice with the predetermined environment parameters.

The analogy unit 150 analogizes the intensity of radio waves of the at least one follower robot 200 that may be received from the at least one lattice. When the analogy unit 150 analogizes the intensity of radio waves of the at least one follower robot 200 that may be received from the at least one lattice, the analogy unit 150 may use a non-parametric density estimation method.

Furthermore, the analogy unit 150 may analogize the intensity of radio waves of the at least one follower robot 200 that may be received from the at least one lattice in accordance with the following Equation 2:

xₙ=arg minₓ_{_{iεX}}{d(x,xᵢ)}

y(x)=y(xₘᵢₙ) (2)

where d(*,*) is a distance function, x is a lattice value, xᵢ is the position in the at least one follower robot, and y(x) is an environment parameter in the lattice x.

The construction unit 160 may construct a radio wave map using the intensity of radio waves of the at least one follower robot 200 that has been analogized for the at least one lattice.

The operation of the apparatus 100 for modeling a radio wave environment in accordance with the embodiment of the present invention, which is configured as described above, will be described below with reference to FIG. 3. In accordance with the apparatus 100 for modeling a radio wave environment in accordance with the embodiment of the present invention, the leader robot 100 equipped with a communication module may receive information about radio waves from the follower robots 200 (200(2), 200(3), and 200(3)) placed in different environments, and may estimate environment parameters at the positions of the follower robots 200 (200(2), 200(3), and 200(3)) using information based on the intensity of radio waves and the relative positions. Furthermore, the apparatus 100 for modeling a radio wave environment may classify environment parameters around the follower robots 200 (200(2), 200(3), and 200(3)) using the estimated environment parameter, and may apply the distances between a lattice and the follower robots 200 (200(2), 200(3), and 200(3)) having the same environment parameter to the wave model, thereby analogizing the intensity of radio waves in each lattice, generating a radio wave map, and analogizing the radius of communication between the robots.

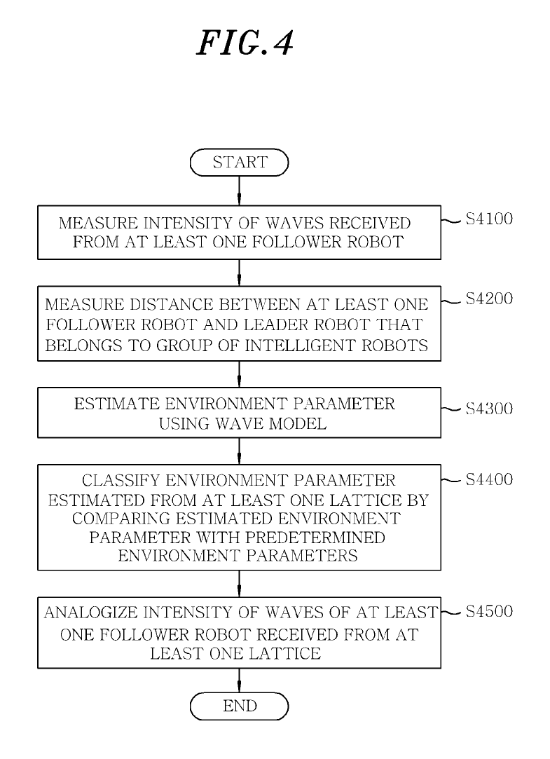

FIG. 4 is a flow chart illustrating a method of modeling a radio wave environment in accordance with an embodiment of the present invention. Referring to FIG. 4, the apparatus for modeling a radio wave environment measures the intensity of radio waves that may be received from at least one follower robot in operation 54100.

The apparatus for modeling a radio wave environment measures the distance between the at least one follower robot and a leader robot that belongs to a group of intelligent robots in operation 54200.

The apparatus for modeling a radio wave environment estimates an environment parameter using a wave model in operation 54300, and classifies the environment parameter estimated from at least one lattice by comparing the estimated environment parameter with predetermined environment parameters in operation 54400.

Finally, the apparatus for modeling a radio wave environment analogizes the intensity of radio waves of the at least one follower robot that may be received from the at least one lattice in operation 54500.

Descriptions that are not given in connection with the method of modeling a radio wave environment illustrated in FIG. 4 are omitted because they are the same as those of the method of modeling a radio wave environment given in conjunction with FIGS. 1 to 3 or because they can be easily inferred from the given descriptions.

The method of modeling a radio wave environment in accordance with an embodiment of the present invention, which has been described in conjunction with FIG. 4, may also be implemented in the form of a computer-readable medium including computer-executable instructions, such as an application or a program module that can be executed by a computer. A computer-readable medium may be a specific available medium that is accessible to a computer, and the computer-readable medium includes volatile and non-volatile media and separate and non-separate type media. Furthermore, the computer-readable medium may include both a computer storage medium and a communication medium. The computer storage medium includes all of computer-readable instructions, a data structure, a program module, and volatile and non-volatile and separate and non-separate type media implemented using a specific method or technique and configured to store other data. The communication medium typically includes computer-readable instructions, a data structure, a program module, other data of a modulated data signal, such as a carrier, other transmission mechanisms, and specific information transfer media.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method of modeling a radio wave environment, the method being executed by a radio wave environment modeling apparatus using a group of intelligent robots, comprising:
measuring an intensity of radio waves received from at least one follower robot;
measuring a distance between the at least one follower robot and a leader robot that belongs to the group of intelligent robots;
estimating an environment parameter using a wave model;
classifying the environment parameter estimated from at least one lattice by comparing the estimated environment parameter with predetermined environment parameters; and
analogizing an intensity of radio waves of the at least one follower robot that are received from the at least one lattice.

2. The method of claim 1, wherein the environment parameter is an attenuation rate of reception power over distance.

3. The method of claim 1, wherein the wave model is a log-distance path loss model.

4. The method of claim 1, wherein the wave model is defined by the following Equation:
$$L = {L}_{0} + {10}_{n} log ( \frac{d}{{d}_{0}} ) + \overline{ω}$$
where L is the reception power, L₀ is reception power at a point d₀ between the at least one follower robot and the leader robot, d is the distance between the at least one follower robot and the leader robot, n is the environment parameter, and ω̅ is noise.

5. The method of claim 1, wherein the environment parameter is estimated using a filter.

6. The method of claim 1, wherein said analogizing an intensity of radio waves of the at least one follower robot that are received from the one or more lattices is performed using a non-parametric density estimation method.

7. The method of claim 1, wherein said analogizing an intensity of radio waves of the at least one follower robot that are received from the at least one lattice is performed based on the following Equation:
xₘᵢₙ=arg minₓ_{_{iεX}}{d(x,xᵢ)}
y(x)=y(xₘᵢₙ)
where d(*,*) is a distance function, x is a lattice value, xᵢ is a position in the at least one follower robot, and y(x) is an environment parameter in the lattice x.

8. The method of claim 1, further comprising constructing a radio wave map using the intensity of radio waves of the at least one follower robot that has been analogized for the at least one lattice.

9. The method of claim 1, wherein an environment in which the at least one follower robot are placed is analogized by comparing the environment parameter estimated from the at least one lattice with the predetermined environment parameters.

10. A apparatus for modeling a radio wave environment using a group of intelligent robots, comprising:
an intensity measurement unit configured to measure an intensity of radio waves received from at least one follower robot;
a distance measurement unit configured to measure a distance between the at least one follower robot and a leader robot that belongs to the group of intelligent robots;
an estimation unit configured to estimate an environment parameter using a wave model;
a classification unit configured to classify the environment parameter estimated from the at least one lattice by comparing the estimated environment parameter with predetermined environment parameters; and
an analogy unit configured to analogize an intensity of radio waves of the at least one follower robot which are capable of being received from the one or more lattices.

11. The apparatus of claim 10, wherein the intensity measurement unit measures the intensity of radio waves using at least one medium between the at least one follower robot and the leader robot.

12. The apparatus of claim 10, wherein the wave model is defined by the following Equation:
$$L = {L}_{0} + {10}_{n} log ( \frac{d}{{d}_{0}} ) + \overline{ω}$$
where L is the reception power, L₀ is reception power at a point d₀ between the at least one follower robot and the leader robot, d is the distance between the at least one follower robot and the leader robot, n is the environment parameter, and ω̅ is noise.

13. The apparatus of claim 10, wherein the analogy unit analogizes the intensity of radio waves of the at least one follower robot that are received from the at least one lattice based on the following Equation:
xₘᵢₙ=arg minₓ_{_{iεX}}{d(x,xᵢ)}
y(x)=y(xₘᵢₙ)
where d(*,*) is a distance function, x is a lattice value, xᵢ is a position in the at least one follower robot, and y(x) is an environment parameter in the lattice x.
